(19) United States
(12) Patent Application Publication
(10) Pub. No.: US 2025/0001769 A1
(43) Pub. Date: Jan. 2, 2025

(54) DRYING SYSTEM AND PRINTING SYSTEM

(71) Applicant: FUJIFILM Corporation, Tokyo (JP)

(72) Inventors: Takashi MITSUYASU, Kanagawa (JP); Kensuke TAKADA, Kanagawa (JP); Yoichi KIMURA, Kanagawa (JP)

(73) Assignee: FUJIFILM Corporation, Tokyo (JP)

(21) Appl. No.: 18/884,129

(22) Filed: Sep. 13, 2024

Related U.S. Application Data
(63) Continuation of application No. PCT/JP2023/007516, filed on Mar. 1, 2023.

(30) Foreign Application Priority Data
Mar. 17, 2022 (JP) 2022-043056

(51) Int. Cl. B41J 11/00; F26B 3/30; F26B 13/08; F26B 13/18

(52) U.S. Cl. CPC B41J 11/00216; B41J 11/0022; B41J 11/0024; F26B 3/30; F26B 13/08; F26B 13/18

(57) ABSTRACT

A drying system constituting a drying zone that supports substrates having a wide range of absorption rates, and a printing system are provided. This object is addressed by a drying system that dries a substrate which has a first surface to which a liquid is applied and which is transported along a transport path, in which a second drying zone in which a second heating apparatus for drying a high-absorption substrate having a relatively high absorption rate with respect to the liquid is disposed is configured upstream of a contact roll that comes into contact with the first surface to which the liquid is applied, on the transport path, and a first drying zone in which a first heating apparatus for drying a low-absorption substrate having a relatively low absorption rate with respect to the liquid is disposed is additionally configurable upstream of the contact roll on the transport path.

### CROSS-REFERENCE TO RELATED APPLICATIONS

The present application is a Continuation of PCT International Application No. PCT/JP2023/007516 filed on Mar. 1, 2023 claiming priority under 35 U.S.C § 119 (a) to Japanese Patent Application No. 2022-043056 filed on Mar. 17, 2022. Each of the above applications is hereby expressly incorporated by reference, in its entirety, into the present application.

### BACKGROUND OF THE INVENTION

### 1. Field of the Invention

The present invention relates to a drying system and a printing system, and particularly to a technology for drying a substrate to which a liquid is applied.

### 2. Description of the Related Art

In a coating apparatus using an aqueous ink, it is required to dry the ink by providing a drying portion after coating with the ink. In the drying portion, drying is promoted by applying thermal energy to a substrate coated with the ink using heated air, a heat roll, an infrared heater, or the like.

For example, JP2020-016353A discloses a technology for heating a transported drying target to which a liquid is applied, using a heating drum and a hot air fan. In addition, JP6849015B discloses a drying apparatus that dries a transported member to which a liquid is applied, using a drying drum and an infrared heater.

### SUMMARY OF THE INVENTION

However, in the technologies disclosed in JP2020-016353A and JP6849015B, a drying heat source cannot be selectively added, and even in a case where only a substrate such as high-quality paper having a relatively high absorption rate is used, a large-size drying mechanism considering use of a substrate having a relatively low absorption rate is required. Thus, a cost of the drying mechanism is increased, and a size of the apparatus is also increased. In addition, adding a heat roll or the like after a printing apparatus is completed changes a transport path and is difficult to implement.

The present invention has been conceived in view of such circumstances, and an object of the present invention is to provide a drying system constituting a drying zone that supports substrates having a wide range of absorption rates, and a printing system.

An aspect of a drying system for achieving the object is a drying system that dries a substrate which has a first surface to which a liquid is applied and which is transported along a transport path, in which a second drying zone in which a second heating apparatus for drying a high-absorption substrate having a relatively high absorption rate with respect to the liquid is disposed is configured upstream of a contact roll that comes into contact with the first surface to which the liquid is applied, on the transport path, and a first drying zone in which a first heating apparatus for drying a low-absorption substrate having a relatively low absorption rate with respect to the liquid is disposed is additionally configurable upstream of the contact roll on the transport path. According to the present aspect, a drying zone that supports substrates having a wide range of absorption rates can be configured, and the liquid applied to the substrate can be prevented from sticking to the contact roll.

It is preferable that the first drying zone is additionally configured. Accordingly, the low-absorption substrate that has a relatively low absorption rate with respect to the liquid can be dried.

It is preferable that the liquid includes a solvent, and the high-absorption substrate is dried by the second drying zone until a residual solvent amount of the liquid applied to the high-absorption substrate reaches 40% or less. Accordingly, the liquid applied to the high-absorption substrate can be prevented from sticking to the contact roll.

It is preferable that the low-absorption substrate is dried by the first drying zone and the second drying zone until the residual solvent amount of the liquid applied to the low-absorption substrate reaches 30% or less. Accordingly, the liquid applied to the low-absorption substrate can be prevented from sticking to the contact roll.

It is preferable that at least one of the first heating apparatus or the second heating apparatus includes an infrared heater that irradiates the first surface with an infrared ray, and a ratio of an amount of time of heating by the infrared heater to a total heating time in which the substrate is heated in the first drying zone and the second drying zone is 50% or less. Accordingly, deformation of the substrate can be prevented.

It is preferable that the first heating apparatus includes at least one of an infrared heater that irradiates the first surface of the substrate with an infrared ray, a heat roll that rotates with a second surface of the substrate opposite to the first surface of the substrate held on a heated peripheral surface of the heat roll, or a heating fan that blows heated air to the first surface of the substrate. Accordingly, the liquid applied to the substrate can be dried.

It is preferable that the second heating apparatus includes at least one of an infrared heater that irradiates the first surface of the substrate with an infrared ray, a heat roll that rotates with a second surface of the substrate opposite to the first surface of the substrate held on a heated peripheral surface of the heat roll, or a heating fan that blows heated air to the first surface of the substrate. Accordingly, the liquid applied to the substrate can be dried.

It is preferable that the drying system comprises a first attaching mechanism, and a first drying unit in which the first heating apparatus and a second attaching mechanism that engages with the first attaching mechanism are configured in an integrated manner. Accordingly, the first drying zone can be additionally configured without affecting a control system and a power supply configuration of a printing apparatus.

It is preferable that the first drying zone is configured while the transport path before adding the first drying zone is maintained. Accordingly, the first drying zone can be additionally configured without affecting the transport path.

It is preferable that a third drying zone in which a third heating apparatus for drying the high-absorption substrate is disposed is configured upstream or downstream of the contact roll on the transport path, and a fourth drying zone in which a fourth heating apparatus for drying the low-absorption substrate is disposed is additionally configurable upstream or downstream of the contact roll on the transport path. Accordingly, a drying zone that supports substrates having a wide range of absorption rates can be configured, and blocking can be prevented.

It is preferable that the fourth drying zone is additionally configured. Accordingly, the low-absorption substrate that has a relatively low absorption rate with respect to the liquid can be dried.

It is preferable that the liquid includes a solvent, and the high-absorption substrate is dried by the second drying zone and the third drying zone until a residual solvent amount of the liquid applied to the high-absorption substrate reaches 20% or less. Accordingly, blocking of the high-absorption substrate can be prevented.

It is preferable that the low-absorption substrate is dried by at least the second drying zone, the third drying zone, and the fourth drying zone until the residual solvent amount of the liquid applied to the low-absorption substrate reaches 15% or less. Accordingly, blocking of the low-absorption substrate can be prevented.

It is preferable that the fourth heating apparatus includes at least one of an infrared heater that irradiates the first surface of the substrate with an infrared ray, a heat roll that rotates with a second surface opposite to the first surface held on a heated peripheral surface of the heat roll, or a heating fan that blows heated air to the first surface. Accordingly, the liquid applied to the substrate can be dried.

It is preferable that the drying system comprises a third attaching mechanism, and a second drying unit in which the fourth heating apparatus and a fourth attaching mechanism that engages with the third attaching mechanism are configured in an integrated manner. Accordingly, the fourth drying zone can be additionally configured without affecting a control system and a power supply configuration of a printing apparatus.

It is preferable that the fourth drying zone is configured while the transport path before adding the fourth drying zone is maintained. Accordingly, the fourth drying zone can be additionally configured without affecting the transport path.

It is preferable that the second drying zone is also used as the third drying zone. Accordingly, size increase of an apparatus can be suppressed.

An aspect of a printing system for achieving the object is a printing system comprising a printing apparatus that applies a liquid to a first surface of a substrate, a transport apparatus that includes a contact roll which comes into contact with the first surface and that transports the substrate along a transport path, and the drying system. According to the present aspect, a drying zone that supports substrates having a wide range of absorption rates can be configured, and the liquid applied to the substrate can be prevented from sticking to the contact roll.

According to the present invention, a drying zone that supports substrates having a wide range of absorption rates can be configured.

### BRIEF DESCRIPTION OF THE DRAWINGS

FIG. 1 is an overall configuration diagram of an ink jet printing apparatus.

FIG. 2 is a configuration diagram of a first ink jet portion and a first additional drying portion.

FIG. 3 is a configuration diagram of the first ink jet portion and the first additional drying portion according to another aspect.

FIGS. 4A and 4B are schematic diagrams illustrating a substrate and moisture included in an aqueous ink with which the substrate is coated.

FIG. 5 is a graph for describing a constant rate drying period and a falling rate drying period.

FIG. 6 is a table illustrating a result of evaluation of a relationship between a residual solvent amount and presence or absence of blocking.

FIG. 7 is a table illustrating a result of evaluation of a relationship between a ratio of use of drying by an infrared heater and substrate deformation.

FIGS. 8A to 8C are diagrams for describing an additional mechanism of a first drying zone.

FIGS. 9A to 9C are diagrams for describing an additional mechanism of a fourth drying zone.

### DESCRIPTION OF THE PREFERRED EMBODIMENTS

Hereinafter, a preferred embodiment of the present invention will be described in accordance with the accompanying drawings.

### <Printing Apparatus>

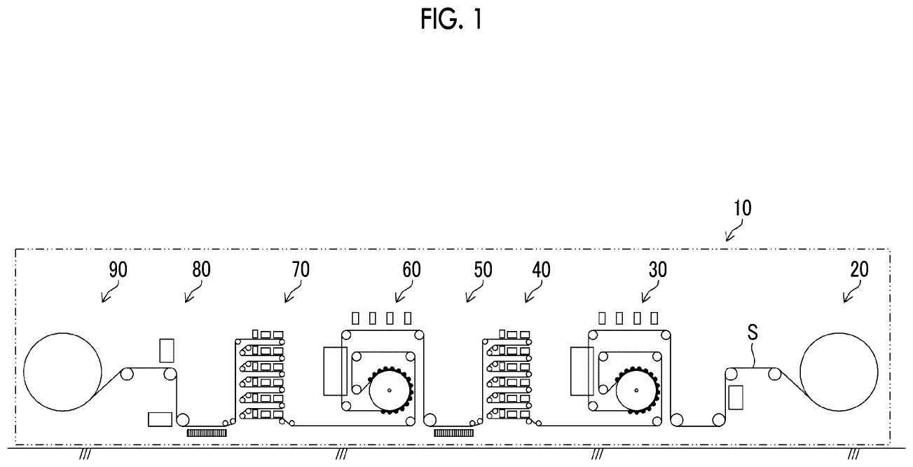

FIG. 1 is an overall configuration diagram of an ink jet printing apparatus 10. The ink jet printing apparatus 10 is a printing system that prints images on a substrate S which is an oblong paper medium, using a single pass method. As illustrated in FIG. 1, the ink jet printing apparatus 10 comprises a paper feeding portion 20, a first ink jet portion 30, a first additional drying portion 40, a substrate inverting portion 50, a second ink jet portion 60, a second additional drying portion 70, an examination portion 80, and a winding portion 90. The substrate S is transported along a transport path from the paper feeding portion 20 to the winding portion 90 by a drive roll (an example of a “transport apparatus”) driven by a motor, not illustrated, using a roll to roll method.

The paper feeding portion 20 comprises a feeding roll on which the substrate S before the images are printed is wound in a roll shape. The substrate S supplied from the feeding roll is transported to the first ink jet portion 30.

The first ink jet portion 30 prints an image by coating (an example of “application”) an outer surface of the substrate S with an aqueous ink (an example of a “liquid”) using an ink jet method while transporting the substrate S transported from the paper feeding portion 20.

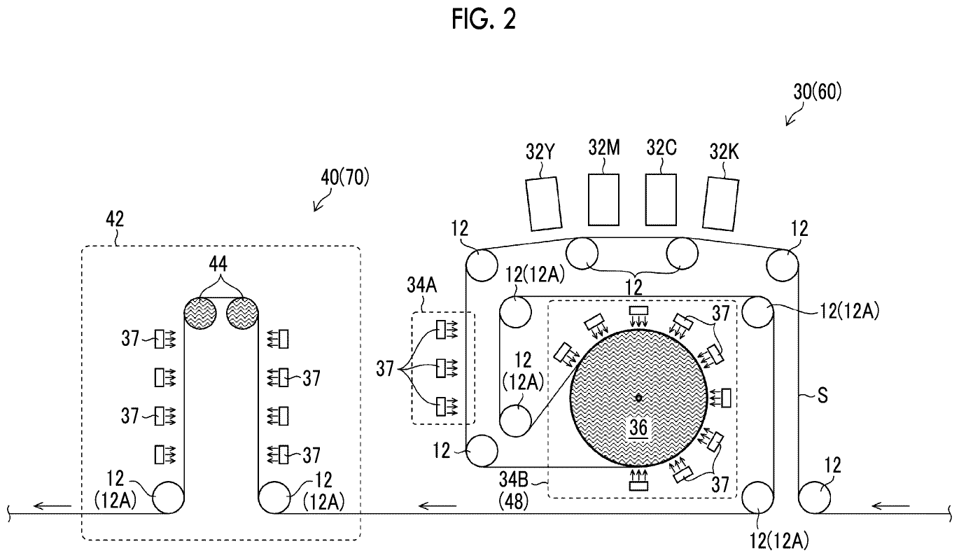

In the ink jet printing apparatus 10 using the aqueous ink, it is required to dry the ink after ink coating. Thus, a first drying zone 34A (refer to FIG. 2) and a second drying zone 34B (refer to FIG. 2) are configured along the transport path of the substrate S in the first ink jet portion 30. In the first drying zone 34A and the second drying zone 34B, the aqueous ink with which the substrate S is coated is dried by applying thermal energy using a heating apparatus, described later. The substrate S discharged from the first ink jet portion 30 is transported to the first additional drying portion 40.

In the first additional drying portion 40, a fourth drying zone 42 (refer to FIG. 2) is configured. In the fourth drying zone 42, the aqueous ink with which the substrate S is coated is dried while the substrate S is transported, by applying thermal energy using a heating apparatus, described later. The substrate S discharged from the first additional drying portion 40 is transported to the substrate inverting portion 50.

The substrate inverting portion 50 includes a turn bar. The turn bar inverts the outer surface and an inner surface of the substrate S. The substrate S of which the outer surface and the inner surface are inverted is transported to the second ink jet portion 60.

The second ink jet portion 60 has the same configuration as the first ink jet portion 30. The second ink jet portion 60 prints an image by coating the inner surface of the substrate S with the aqueous ink using the ink jet method and dries the aqueous ink with which the substrate S is coated. The substrate S discharged from the second ink jet portion 60 is transported to the second additional drying portion 70.

The second additional drying portion 70 has the same configuration as the first additional drying portion 40. The second additional drying portion 70 dries the aqueous ink with which the substrate S is coated, while transporting the substrate S. The substrate S discharged from the second additional drying portion 70 is transported to the examination portion 80.

The examination portion 80 examines the images printed on the outer surface and the inner surface of the substrate S. The examination portion 80 includes a scanner that images the outer surface of the substrate S, and a scanner that images the inner surface of the substrate S. In addition, the ink jet printing apparatus 10 includes a processor, not illustrated, that determines quality of images captured by the scanners. The substrate S of which the images are examined by the examination portion 80 is transported to the winding portion 90.

The winding portion 90 comprises a winding roll (an example of the “transport apparatus”) connected to a motor, not illustrated. In the winding portion 90, the substrate S on which the images are printed is wound on the winding roll by rotationally driving the winding roll using the motor, not illustrated.

As described above, the ink jet printing apparatus 10 manufactures a printed article by transporting the substrate S in an order of the paper feeding portion 20, the first ink jet portion 30, the first additional drying portion 40, the substrate inverting portion 50, the second ink jet portion 60, the second additional drying portion 70, the examination portion 80, and the winding portion 90 and performing processing of each portion on the substrate S.

### <Drying Zone>

FIG. 2 is a configuration diagram of the first ink jet portion 30 including a drying system according to the present embodiment and the first additional drying portion 40. The same configuration applies to the second ink jet portion 60 and the second additional drying portion 70, as described above. FIG. 2 is an illustration that is more simplified than FIG. 1.

As illustrated in FIG. 2, the first ink jet portion 30 comprises a plurality of pass rolls 12, ink jet heads 32K, 32C, 32M, and 32Y, the first drying zone 34A, the second drying zone 34B, and a third drying zone 48. Here, the second drying zone 34B is also used as the third drying zone 48. The substrate S transported to the first ink jet portion 30 from the paper feeding portion 20 is guided by the pass rolls 12 and transported in the first ink jet portion 30.

Each of the ink jet heads 32K, 32C, 32M, and 32Y (an example of a “printing apparatus”) is a line type recording head capable of performing printing on the transported substrate S by performing scanning one round. The ink jet heads 32K, 32C, 32M, and 32Y are disposed at certain intervals along the transport path. Each of the ink jet heads 32K, 32C, 32M, and 32Y comprises a nozzle surface, not illustrated, on which a plurality of nozzles that are outlets of the aqueous ink are two-dimensionally arranged. The nozzle surfaces are disposed to face the substrate S.

The ink jet heads 32K, 32C, 32M, and 32Y are supplied with the aqueous ink of black (K), cyan (C), magenta (M), and yellow (Y), respectively, from ink tanks, not illustrated, through pipe paths, not illustrated. The aqueous ink refers to an ink obtained by dissolving or dispersing a coloring material such as a dye or a pigment in water and in a water-soluble solvent. Here, an aqueous pigment ink is used as the aqueous ink. An organic-based pigment is used as the pigment of the aqueous ink of each of black, cyan, magenta, and yellow.

Each of the ink jet heads 32K, 32C, 32M, and 32Y jets liquid droplets of the aqueous ink toward the substrate S. A printed surface (an example of a “first surface”) of the substrate S is coated with the jetted liquid droplets, and the image is printed on the printed surface of the substrate S.

While a configuration in which the aqueous ink of four colors is used is illustrated here, an ink color and the number of colors are not limited to the present embodiment. For example, an ink jet head that jets a light ink such as light magenta or light cyan, a special color ink such as green, orange, or violet, a clear ink, or a metallic ink may be added. In addition, an order in which the ink jet heads of each color are disposed is not limited.

The substrate S on which color images are printed by the ink jet heads 32K, 32C, 32M, and 32Y is guided by the pass rolls 12 and passes through the first drying zone 34A.

In the first drying zone 34A, a plurality of heating fans 37 (an example of a “first heating apparatus”) are disposed as an auxiliary drying apparatus. Each of the plurality of heating fans 37 comprises an outlet, not illustrated, for blowing out heated air, and the outlets are disposed to face the transport path of the substrate S. The plurality of heating fans 37 blow the heated air to the printed surface (A surface) of the substrate S from their respective outlets. Accordingly, the printed surface of the substrate S passing through the first drying zone 34A is heated by the heated air, and drying of the aqueous ink with which the printed surface is coated is promoted.

In the first drying zone 34A, an infrared heater that irradiates the printed surface of the substrate S with an infrared ray, and a heat roll that rotates with a surface (B surface) of the substrate S opposite to the printed surface of the substrate S held on its heated peripheral surface may be disposed.

The substrate S that has passed through the first drying zone 34A then passes through the second drying zone 34B. In the second drying zone 34B, a first heat roll 36 (an example of a “second heating apparatus” and an example of a “third heating apparatus”) and a plurality of heating fans 37 (an example of the “second heating apparatus” and an example of the “third heating apparatus”) are disposed.

The first heat roll 36 is rotationally driven by a motor, not illustrated. In addition, a peripheral surface of the first heat roll 36 is heated by a heater, not illustrated. The first heat roll 36 transports the substrate S while heating the substrate S from the surface opposite to the printed surface, by rotating with the surface (an example of a “second surface”) of the substrate S opposite to the printed surface of the substrate S held on its peripheral surface. Accordingly, the substrate S passing through the second drying zone 34B is heated by the first heat roll 36, and drying of the aqueous ink with which the printed surface is coated is promoted.

In each of the plurality of heating fans 37, an outlet is disposed to face the transport path of the substrate S. The plurality of heating fans 37 blow heated air to the printed surface of the substrate S from their respective outlets. Accordingly, the printed surface of the substrate S passing through the second drying zone 34B is heated by the heated air, and drying of the aqueous ink with which the printed surface is coated is promoted.

In the second drying zone 34B, an infrared heater that irradiates the printed surface of the substrate S with an infrared ray may be disposed.

The substrate S that has passed through the second drying zone 34B is transported to the first additional drying portion 40 from the first ink jet portion 30 by A surface touch rolls 12A (an example of a “contact roll”) that are the pass rolls 12 coming into contact with the printed surface. The substrate S transported to the first additional drying portion 40 is transported in the first additional drying portion 40.

As illustrated in FIG. 2, the first additional drying portion 40 comprises the fourth drying zone 42. In the fourth drying zone 42, a plurality of A surface touch rolls 12A, a plurality of second heat rolls 44 (an example of a “fourth heating apparatus”), and a plurality of heating fans 37 (an example of the “fourth heating apparatus”) are disposed.

While the second heat rolls 44 have the same configuration as the first heat roll 36, the second heat rolls 44 have a relatively smaller diameter than the first heat roll 36. The second heat rolls 44 transport the substrate S while heating the substrate S from the surface opposite to the printed surface, by rotating with the substrate S wound on their respective peripheral surfaces. Accordingly, the substrate S passing through the fourth drying zone 42 is heated by the second heat rolls 44, and drying of the aqueous ink with which the printed surface is coated is promoted.

In each heating fan 37, an outlet is disposed to face the transport path of the substrate S. The heating fans 37 blow heated air to the printed surface of the substrate S from their respective outlets. Accordingly, the printed surface of the substrate S passing through the fourth drying zone 42 is heated by the heated air, and drying of the aqueous ink with which the printed surface is coated is promoted.

In the fourth drying zone 42, an infrared heater that irradiates the printed surface of the substrate S with an infrared ray, and a heat roll that rotates with the printed surface of the substrate S held on its heated peripheral surface may be disposed. The substrate S that has passed through the fourth drying zone 42 is transported to the substrate inverting portion 50 (refer to FIG. 1) from the first additional drying portion 40.

The first drying zone 34A and the fourth drying zone 42 are configured to be additionally configured in the ink jet printing apparatus 10 as a base, as necessary. That is, the first drying zone 34A and the fourth drying zone 42 are not provided in the ink jet printing apparatus 10 as the base. The same applies to the second ink jet portion 60 and the second additional drying portion 70.

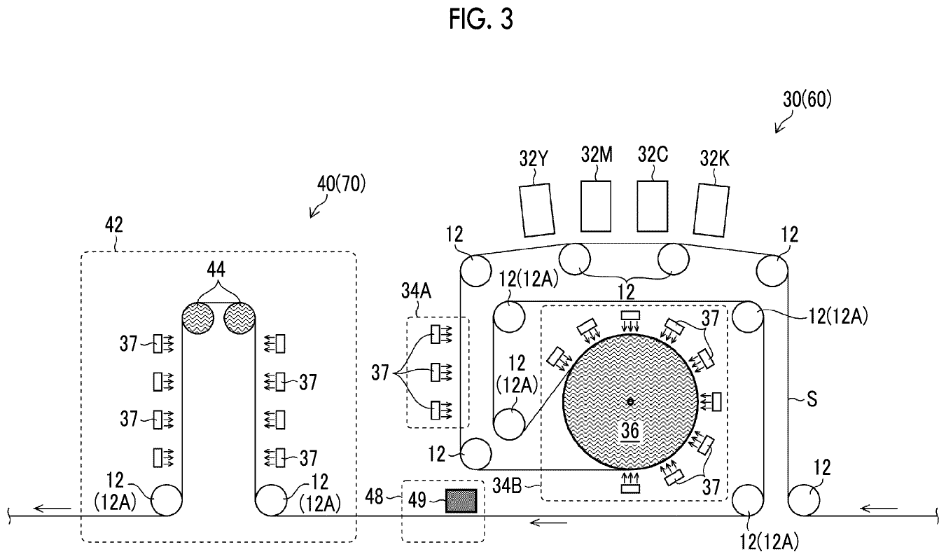

The third drying zone 48 may be configured downstream of the initial A surface touch roll 12A on the transport path of the substrate S separately from the second drying zone 34B, instead of being configured in common with the second drying zone 34B. FIG. 3 is a configuration diagram of the first ink jet portion 30 and the first additional drying portion 40 according to another aspect.

As illustrated in FIG. 3, the third drying zone 48 is configured downstream of the initial A surface touch roll 12A on the transport path of the substrate S and upstream of the first additional drying portion 40. An infrared heater 49 is disposed in the third drying zone 48. The infrared heater 49 heats the substrate S by irradiating the printed surface of the transported substrate S with an infrared ray. In the third drying zone 48, a heating fan that blows heated air from an outlet, and a heat roll that rotates with the printed surface of the substrate S or the surface opposite to the printed surface held on its heated peripheral surface may be disposed.

### <Calculation of Heat Amount Required for Drying>

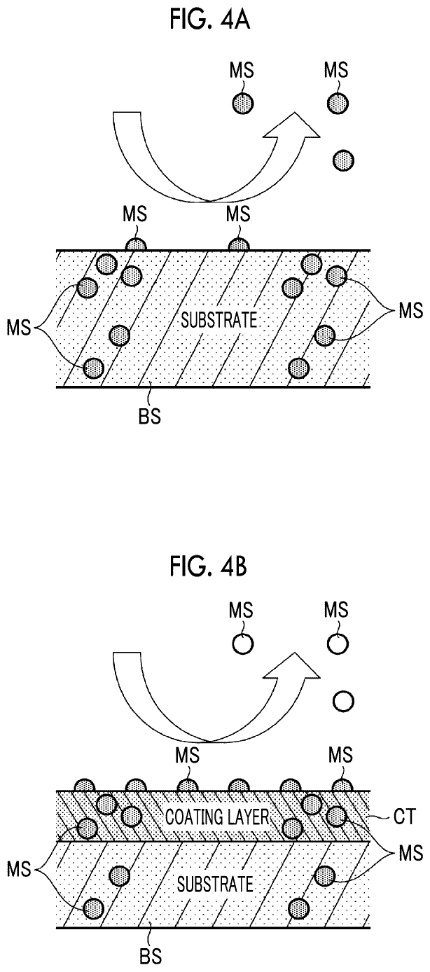

FIGS. 4A and 4B are schematic diagrams illustrating the substrate S and moisture included in the aqueous ink with which the substrate S is coated. FIG. 4A illustrates a case where the substrate S is high-quality paper, and FIG. 4B illustrates a case where the substrate S is coated paper. The high-quality paper is a high-absorption substrate having a relatively high absorption rate with respect to the aqueous ink. Meanwhile, the coated paper is a low-absorption substrate having a relatively low absorption rate with respect to the aqueous ink. The coated paper includes glossy coated paper, matte coated paper, and the like.

As illustrated in FIG. 4A, the substrate S as the high-quality paper of which a support BS is exposed can absorb a large amount of moisture MS in the support BS. Meanwhile, as illustrated in FIG. 4B, in the coated paper, a coating layer CT that does not easily absorb the moisture MS is present on an outer surface of the support BS. The coating layer CT including the moisture MS is brittle and is likely to cause a failure such as peeling. Accordingly, in a case where the coated paper is coated with the aqueous ink, it is required to dry the moisture MS of the coating by applying a large heat amount, instead of causing the moisture MS to be absorbed in the support BS and the coating layer CT. Thus, drying of the coated paper is generally known as requiring a larger heat amount than drying of the high-quality paper.

The second drying zone 34B that is a base drying zone configured in the ink jet printing apparatus 10 as the base is used for drying the high-quality paper having a relatively high absorption rate. In order to construct the second drying zone 34B, a heat amount required for drying the high-quality paper is obtained. This can be obtained by either calculation or experiment. Since a load of drying is large, the heat amount is calculated using the largest thickness in a range of a thickness of the substrate S to be used.

The second drying zone 34B is configured in accordance with the heat amount. Even with the high-quality paper, the aqueous ink of the coating sticks to the A surface touch rolls 12A in a case where the A surface touch rolls 12A come into contact with the printed surface that is not dried yet. Thus, the A surface touch rolls 12A are disposed downstream of the second drying zone 34B on the transport path of the substrate S. In addition, a space in which the first drying zone 34A can be added is secured upstream of the A surface touch rolls 12A on the transport path of the substrate S.

The first drying zone 34A that can be additionally configured in the ink jet printing apparatus 10 as the base, and the fourth drying zone 42 are used for drying the coated paper having a relatively low absorption rate. In order to construct the first drying zone 34A and the fourth drying zone 42, a heat amount required for drying the coated paper is obtained. Here, two heat amounts including a heat amount required for enabling contact with the printed surface of the substrate S and a heat amount required before winding are obtained.

The first drying zone 34A is added upstream of the A surface touch roll 12A that initially comes into contact with the printed surface, on the transport path based on the applied heat amount required before making contact with the printed surface. In addition, the fourth drying zone 42 is added downstream of the A surface touch roll 12A that initially comes into contact with the printed surface, on the transport path based on the applied heat amount required before winding.

By configuring the added first drying zone 34A and the added fourth drying zone 42 as independent units, a sufficient drying zone can be added without significantly affecting the ink jet printing apparatus 10 as the base. Here, independent units mean that the units do not affect each other in a transport path system, a control system, and a power supply configuration.

### <Concept of Ink Drying>

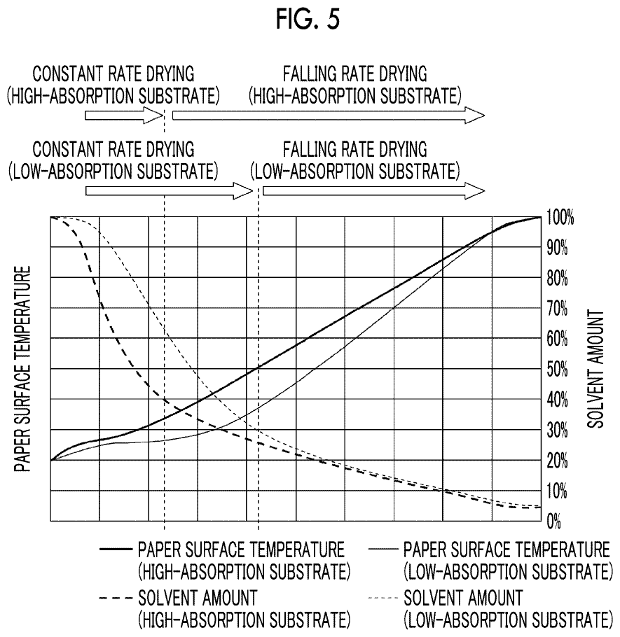

A drying process of the aqueous ink is divided into a constant rate drying period and a falling rate drying period. FIG. 5 is a graph for describing the constant rate drying period and the falling rate drying period in a case where the substrate coated with the aqueous ink is dried with a certain heat amount. In this graph, a horizontal axis denotes a drying time, a vertical axis on the left denotes a paper surface temperature (an outer surface temperature of the substrate), and a vertical axis on the right denotes a residual solvent amount of the substrate. The residual solvent amount is in % units. Here, each of the high-absorption substrate and the low-absorption substrate is illustrated.

The constant rate drying period is a period in which the aqueous ink of the coating mainly evaporates on a gas-liquid interface. In the constant rate drying period, a rate of increase in the paper surface temperature is relatively low, and a rate of decrease in the residual solvent amount is relatively high. Meanwhile, the falling rate drying period is a period in which the aqueous ink that has permeated into the substrate evaporates. In the falling rate drying period, the rate of increase in the paper surface temperature is relatively high, and the rate of decrease in the residual solvent amount is relatively low. As illustrated in FIG. 5, a period until the residual solvent amount reaches 40% or less is the constant rate drying period for the high-absorption substrate, and a period until the residual solvent amount reaches 30% or less is the constant rate drying period for the low-absorption substrate.

In a case where the printed surface comes into contact with the A surface touch rolls 12A during the constant rate drying period, picking that means removal of the aqueous ink by the A surface touch rolls 12A occurs. Thus, a drying zone is composed of an infrared heater and a heating fan that are contactless heating apparatuses, and a heat roll that supports the surface opposite to the printed surface, so that contact is not made with the printed surface in the drying zone before the constant rate drying period ends.

In a case where a sufficient amount of time elapses after the falling rate drying period starts, the picking does not occur even in a case where the printed surface comes into contact with the A surface touch rolls 12A. Accordingly, in order to prevent the picking on the A surface touch rolls 12A, the A surface touch rolls 12A come into contact with the printed surface after the residual solvent amount reaches 40% or less for the high-absorption substrate and after the residual solvent amount reaches 30% or less for the low-absorption substrate. In the drying zone in the falling rate drying period, it is desirable to use the heated air and the heat roll and not use the infrared heater that may deteriorate deformation of the substrate S.

In the drying zone downstream of the A surface touch rolls 12A on the transport path, it is required to dry the substrate to a degree in which blocking does not occur in a case where the substrate is finally wound. In addition, since the low-absorption substrate is relatively more likely to cause the blocking than the high-absorption substrate, a higher degree of drying is required for the low-absorption substrate. Here, the blocking refers to a phenomenon in which substrates that overlap with each other after being wound stick to each other.

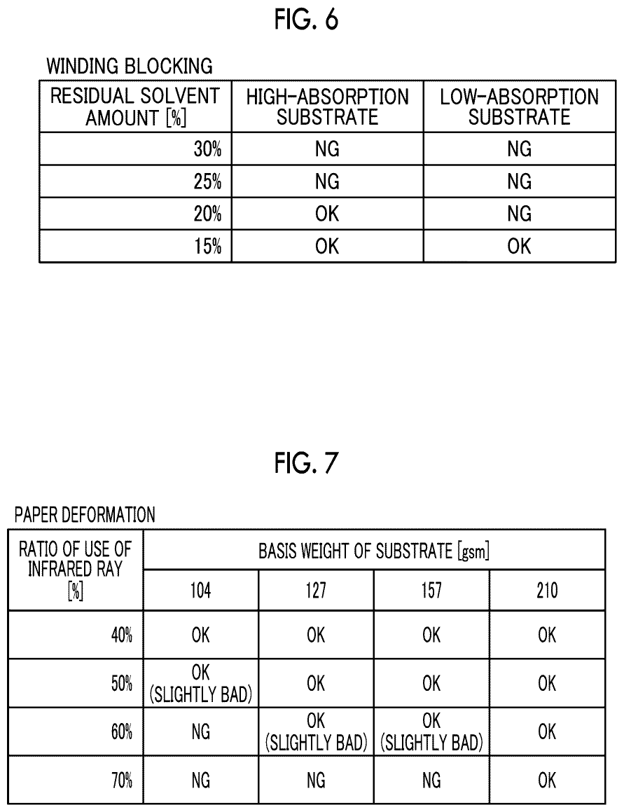

FIG. 6 is a table illustrating a result of evaluation of a relationship between the residual solvent amount and presence or absence of the blocking in winding the substrate. In FIG. 6, “OK” indicates a case where the blocking does not occur, and “NG” indicates a case where the blocking occurs.

As illustrated in FIG. 6, in the high-absorption substrate, the blocking occurs in a case where the residual solvent amount is 30% and 25%, and the blocking does not occur in a case where the residual solvent amount is 20% and 15%. Meanwhile, in the low-absorption substrate, the blocking occurs in a case where the residual solvent amount is 30%, 25%, and 20%, and the blocking does not occur in a case where the residual solvent amount is 15%.

From the above, it is perceived that the lower residual solvent amount that does not cause the blocking in winding is lower for the low-absorption substrate that has relatively high smoothness of the outer surface of the substrate.

### <Different Uses of Various Heating Apparatuses>

### [Infrared Heater]

The infrared heater has a difference in a heat absorption rate depending on a color of an irradiation target of the infrared ray. Thus, in a case where the infrared heater is used in a second half of the drying process (downstream of the A surface touch roll that initially comes into contact with the printed surface on the transport path), remaining moisture of the printed article varies depending on the color of the printed image, and this particularly deteriorates deformation of the substrate. Accordingly, it is not preferable to use the infrared heater in the second half of the drying process. Meanwhile, the infrared heater is contactless and has relatively high thermal efficiency. Thus, the infrared heater is used in a first half of the drying process (upstream of the A surface touch roll that initially comes into contact with the printed surface on the transport path).

FIG. 7 is a table illustrating a result of evaluation of a relationship between substrate deformation and a ratio of use of the infrared heater in the drying zone upstream of the A surface touch roll that initially comes into contact with the printed surface on the transport path. The ratio of use of the infrared heater is a ratio of an amount of time of heating by the infrared heater to a total heat time in which the substrate is heated. Here, each of substrates having basis weights of 104 gsm (g/m²), 127 gsm, 157 gsm, and 210 gsm is evaluated. In FIG. 7, “OK” indicates a case where the substrate deformation falls within an allowable range, and “NG” indicates a case where the substrate deformation falls outside the allowable range.

As illustrated in FIG. 7, in a case where the ratio of use of the infrared heater is 40%, the substrates having basis weights of 104 gsm, 127 gsm, 157 gsm, and 210 gsm fall within the allowable range. In a case where the ratio of use of the infrared heater is 50%, the substrate having a basis weight of 104 gsm is slightly deformed, but the substrates of 104 gsm, 127 gsm, 157 gsm, and 210 gsm fall within the allowable range.

Meanwhile, in a case where the ratio of use of the infrared heater is 60%, the substrate having a basis weight of 104 gsm falls outside the allowable range. In addition, in a case where the ratio of use of the infrared heater is 70%, the substrates having basis weights of 104 gsm, 127 gsm, and 157 gsm fall outside the allowable range.

From this result, it is perceived that in a case where the ratio of the amount of time of heating by the infrared heater to the total heat time in which the substrate is heated exceeds 50%, the substrate deforms, which is not preferable. In addition, it is perceived that in a case where the ratio of the amount of time of heating by the infrared heater to the total heat time in which the substrate is heated is 50% or less, the substrate does not deform, which is preferable.

### [Heat Roll]

The heat roll comes into contact with the substrate and thus, has high heat transfer efficiency to the substrate. However, the heat roll can come into contact with the printed surface after the second half of the drying process starts. In a case where the heat roll is used in the first half of the drying process, research such as using a large-diameter drum having a relatively large diameter or disposing multiple small-diameter rolls having a relatively small diameter to make contact with only the surface opposite to the printed surface over a long distance is required.

### [Heating Fan]

The heated air provided by the heating fan does not have high thermal efficiency but not only applies thermal energy but also provides a drying effect based on a difference in humidity and an effect of ability to substitute air including a large amount of an evaporated solvent with fresh air. The heated air can be used in either the first half or the second half of the drying process. Since the heated air is contactless, it is effective to use the heated air on the printed surface.

### <Summary of Drying Zone>

As described above, in a case where the high-absorption substrate is used, the ink jet printing apparatus 10 as the base is used, and the high-absorption substrate is dried using the second drying zone 34B. Specifically, the heat amount of the second drying zone 34B is determined to dry the high-absorption substrate to a degree in which contact can be made with the printed surface before the high-absorption substrate reaches the A surface touch roll 12A that initially comes into contact with the printed surface. For example, the heat amount of the second drying zone 34B is a heat amount with which the high-absorption substrate is dried until the residual solvent amount of the liquid with which the high-absorption substrate is coated reaches 40% or less.

In addition, the heat amount of the second drying zone 34B is determined to dry the high-absorption substrate to a degree in which the blocking does not occur in winding by the winding portion 90. For example, the heat amount of the second drying zone 34B is a heat amount with which the high-absorption substrate is dried until the residual solvent amount of the liquid with which the high-absorption substrate is coated reaches 20% or less.

Accordingly, the ink jet printing apparatus 10 as the base is completed.

Meanwhile, in a case where the low-absorption substrate is used, the first drying zone 34A and the fourth drying zone 42 are additionally configured in the ink jet printing apparatus 10 as the base.

The heat amount of the first drying zone 34A is determined to dry the low-absorption substrate to a degree in which contact can be made with the printed surface before the low-absorption substrate reaches the A surface touch roll that initially comes into contact with the printed surface. For example, the heat amount of the first drying zone 34A is a heat amount with which the low-absorption substrate is dried by the first drying zone 34A and the second drying zone 34B until the residual solvent amount of the liquid with which the low-absorption substrate is coated reaches 30% or less.

In addition, the heat amount of the fourth drying zone 42 is determined to dry the low-absorption substrate to a degree in which the blocking does not occur in winding by the winding portion 90. For example, the heat amount of the fourth drying zone 42 is a heat amount with which the low-absorption substrate is dried by the first drying zone 34A, the second drying zone 34B, and the fourth drying zone 42 until the residual solvent amount of the liquid with which the low-absorption substrate is coated reaches 15% or less.

The third drying zone 48 may be provided to dry the low-absorption substrate to a degree in which contact can be made with the printed surface before the low-absorption substrate reaches the A surface touch roll that initially comes into contact with the printed surface.

By configuring the drying zone as described above, drying properties enabling contact with the printed surface and blocking resistance in winding can be satisfied for the high-absorption substrate and the low-absorption substrate. For any of the drying properties enabling contact with the printed surface and the blocking resistance in winding, it is required to reduce the moisture in the low-absorption substrate relative to the high-absorption substrate.

The heat amount required for drying in a case where printing is performed on the outer surface of the substrate S may be considered to be the same as the heat amount required for drying in a case where printing is performed on the inner surface of the substrate S.

### <Additional Mechanism of First Drying Zone>

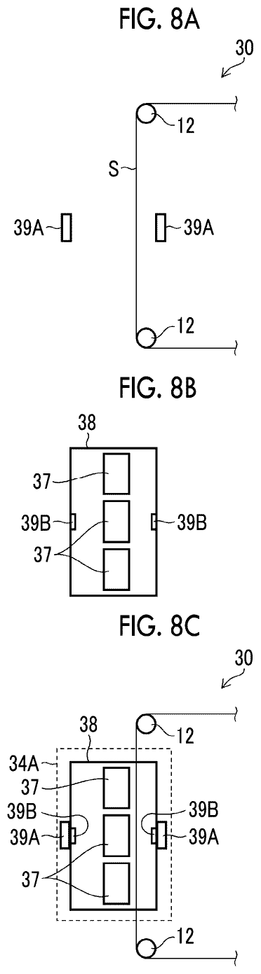

FIGS. 8A to 8C are diagrams for describing an additional mechanism of the first drying zone 34A. FIG. 8A illustrates a part of the first ink jet portion 30 in a state where the first drying zone 34A is not configured. As illustrated in FIG. 8A, in the first ink jet portion 30, the transport path of the substrate S is composed of the plurality of pass rolls 12. In addition, the first ink jet portion 30 comprises a first attaching mechanism 39A.

FIG. 8B is a diagram illustrating a first drying unit 38 for configuring the first drying zone 34A. The first drying unit 38 has a structure in which the plurality of heating fans 37 are integrated with a second attaching mechanism 39B that engages with the first attaching mechanism 39A. The first drying unit 38 is positioned and attached to the ink jet printing apparatus 10 by the first attaching mechanism 39A and the second attaching mechanism 39B.

FIG. 8C illustrates the first drying zone 34A that is configured by causing the second attaching mechanism 39B of the first drying unit 38 to engage with the first attaching mechanism 39A. As illustrated in FIG. 8C, in the first drying zone 34A, the plurality of heating fans 37 are disposed on the transport path of the substrate S.

From the above, the first drying zone 34A is configured to be added by the first drying unit 38 while the transport path of the substrate S before adding the first drying zone 34A is maintained.

Here, while the first attaching mechanism 39A and the second attaching mechanism 39B that are members for positioning and attaching are prepared in advance in both of the ink jet printing apparatus 10 as the base and the first drying unit 38, processing for positioning and attaching may be prepared.

### <Additional Mechanism of Fourth Drying Zone>

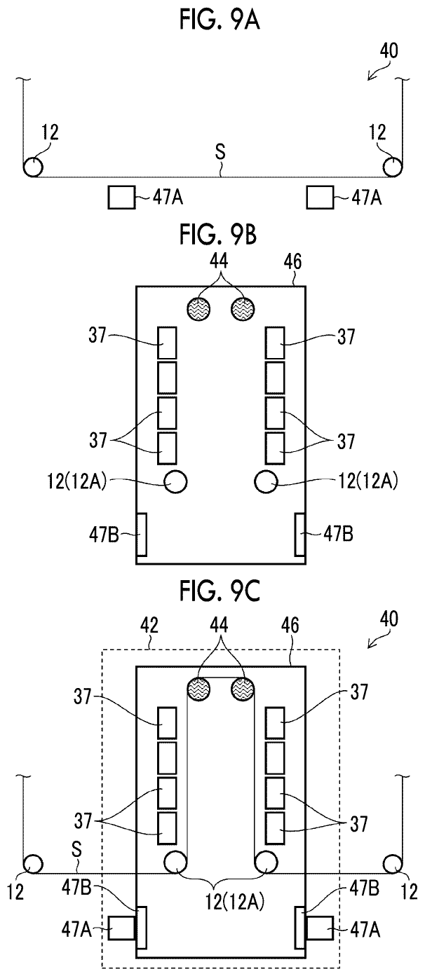

FIGS. 9A to 9C are diagrams for describing an additional mechanism of the fourth drying zone 42. FIG. 9A illustrates the first additional drying portion 40 in a state where the fourth drying zone 42 is not configured. As illustrated in FIG. 9A, in the first additional drying portion 40, the transport path of the substrate S is composed of the plurality of pass rolls 12. In addition, the first additional drying portion 40 comprises a third attaching mechanism 47A.

FIG. 9B is a diagram illustrating a second drying unit 46 for configuring the fourth drying zone 42. The second drying unit 46 has a structure in which the plurality of A surface touch rolls 12A, the plurality of heating fans 37, the plurality of second heat rolls 44, and a fourth attaching mechanism 47B that engages with the third attaching mechanism 47A are integrated with each other. The second drying unit 46 is positioned and attached to the ink jet printing apparatus 10 by the third attaching mechanism 47A and the fourth attaching mechanism 47B.

FIG. 9C illustrates the fourth drying zone 42 that is configured by causing the fourth attaching mechanism 47B of the second drying unit 46 to engage with the third attaching mechanism 47A. As illustrated in FIG. 9C, in the fourth drying zone 42, an additional transport path for transporting the substrate S in an order of the A surface touch roll 12A, the second heat roll 44, the second heat roll 44, and the A surface touch roll 12A is configured. In addition, two second heat rolls 44 and eight heating fans 37 are disposed on the additional transport path. The fourth drying zone 42 is configured to be added while the transport path of the substrate S other than the first additional drying portion 40 is maintained.

From the above, the fourth drying zone 42 is configured to be added by the second drying unit 46. The fourth drying zone 42 may be configured to be added while the transport path of the substrate S of the first additional drying portion 40 before adding the fourth drying zone 42 is maintained. In addition, the first drying zone 34A may be added by configuring an additional transport path as in the fourth drying zone 42.

Here, while the third attaching mechanism 47A and the fourth attaching mechanism 47B that are members for positioning and attaching are prepared in advance in both of the ink jet printing apparatus 10 as the base and the second drying unit 46, processing for positioning and attaching may be prepared.

### <Other>

According to the present aspect, the drying zone is divided into two sections before and after the A surface touch rolls 12A, and the drying zone can be selectively added depending on the absorption rate of the substrate. Thus, a printing apparatus that can support substrates having a wide range of absorption rates can be implemented using one printing apparatus as a base.

A drying apparatus according to the present embodiment is not limited to the ink jet printing apparatus and can be applied to a printing apparatus that forms an image by coating with an aqueous ink.

While an example of performing printing and drying while transporting a long substrate roll to roll has been described here, transport of the substrate is not limited to roll to roll, and the substrate is also not limited to a long substrate. The drying apparatus according to the present embodiment can also be applied to a printing apparatus that performs printing and drying while transporting a single wafer of paper as a substrate one sheet at a time and that stacks the substrate on a sheet discharge tray. While constituents of the transport pass path of the substrate are pass rolls in the present embodiment, constituents of the transport pass path of the substrate in the single wafer printing apparatus are guide plates and transport drums.

The technical scope of the present invention is not limited to the scope according to the embodiment. Configurations and the like in each embodiment can be appropriately combined with each other between the embodiments without departing from the gist of the present invention.

### EXPLANATION OF REFERENCES

10: ink jet printing apparatus
12: pass roll
12A: A surface touch roll
20: paper feeding portion
30: first ink jet portion
32C: ink jet head
32K: ink jet head
32M: ink jet head
32Y: ink jet head
34A: first drying zone
34B: second drying zone
36: first heat roll
37: heating fan
38: first drying unit
39A: first attaching mechanism
39B: second attaching mechanism
40: first additional drying portion
42: fourth drying zone
44: second heat roll
46: second drying unit
47A: third attaching mechanism
47B: fourth attaching mechanism
48: third drying zone
49: infrared heater
50: substrate inverting portion
60: second ink jet portion
70: second additional drying portion
80: examination portion
90: winding portion
BS: support
CT: coating layer
S: substrate

What is claimed is:

1. A drying system that dries a substrate which has a first surface to which a liquid is applied and which is transported along a transport path,
wherein a second drying zone in which a second heating apparatus for drying a high-absorption substrate having a relatively high absorption rate with respect to the liquid is disposed is configured upstream of a contact roll that comes into contact with the first surface to which the liquid is applied, on the transport path, and
a first drying zone in which a first heating apparatus for drying a low-absorption substrate having a relatively low absorption rate with respect to the liquid is disposed is additionally configurable upstream of the contact roll on the transport path.

2. The drying system according to claim 1,
wherein the first drying zone is additionally configured.

3. The drying system according to claim 1,
wherein the liquid includes a solvent, and
the high-absorption substrate is dried by the second drying zone until a residual solvent amount of the liquid applied to the high-absorption substrate reaches 40% or less.

4. The drying system according to claim 3,
wherein the low-absorption substrate is dried by the first drying zone and the second drying zone until the residual solvent amount of the liquid applied to the low-absorption substrate reaches 30% or less.

5. The drying system according to claim 1
wherein at least one of the first heating apparatus or the second heating apparatus includes an infrared heater that irradiates the first surface with an infrared ray, and
a ratio of an amount of time of heating by the infrared heater to a total heating time in which the substrate is heated in the first drying zone and the second drying zone is 50% or less.

6. The drying system according to claim 1,
wherein the first heating apparatus includes at least one of an infrared heater that irradiates the first surface of the substrate with an infrared ray, a heat roll that rotates with a second surface of the substrate opposite to the first surface of the substrate held on a heated peripheral surface of the heat roll, or a heating fan that blows heated air to the first surface of the substrate.

7. The drying system according to claim 1,
wherein the second heating apparatus includes at least one of an infrared heater that irradiates the first surface of the substrate with an infrared ray, a heat roll that rotates with a second surface of the substrate opposite to the first surface of the substrate held on a heated peripheral surface of the heat roll, or a heating fan that blows heated air to the first surface of the substrate.

8. The drying system according to claim 1, comprising:
a first attaching mechanism; and
a first drying unit in which the first heating apparatus and a second attaching mechanism that engages with the first attaching mechanism are configured in an integrated manner.

9. The drying system according to claim 1,
wherein the first drying zone is configured while the transport path before adding the first drying zone is maintained.

10. The drying system according to claim 1
wherein a third drying zone in which a third heating apparatus for drying the high-absorption substrate is disposed is configured upstream or downstream of the contact roll on the transport path, and
a fourth drying zone in which a fourth heating apparatus for drying the low-absorption substrate is disposed is additionally configurable upstream or downstream of the contact roll on the transport path.

11. The drying system according to claim 10,
wherein the fourth drying zone is additionally configured.

12. The drying system according to claim 10,
wherein the liquid includes a solvent, and
the high-absorption substrate is dried by the second drying zone and the third drying zone until a residual solvent amount of the liquid applied to the high-absorption substrate reaches 20% or less.

13. The drying system according to claim 12,
wherein the low-absorption substrate is dried by at least the second drying zone, the third drying zone, and the fourth drying zone until the residual solvent amount of the liquid applied to the low-absorption substrate reaches 15% or less.

14. The drying system according to claim 10
wherein the fourth heating apparatus includes at least one of an infrared heater that irradiates the first surface of the substrate with an infrared ray, a heat roll that rotates with a second surface opposite to the first surface held on a heated peripheral surface of the heat roll, or a heating fan that blows heated air to the first surface.

15. The drying system according to claim 10, comprising:
a third attaching mechanism; and
a second drying unit in which the fourth heating apparatus and a fourth attaching mechanism that engages with the third attaching mechanism are configured in an integrated manner.

16. The drying system according to claim 10,
wherein the fourth drying zone is configured while the transport path before adding the fourth drying zone is maintained.

17. The drying system according to claim 10,
wherein the second drying zone is also used as the third drying zone.

18. A printing system comprising:
a printing apparatus that applies a liquid to a first surface of a substrate;
a transport apparatus that includes a contact roll which comes into contact with the first surface and that transports the substrate along a transport path; and
the drying system according to claim 1.
